(19) United States
(12) Patent Application Publication
(10) Pub. No.: US 2010/0173268 A1
(43) Pub. Date: Jul. 8, 2010

(54) PORTABLE TRACING DEVICE

(76) Inventors: Michael Smiley, Fresno, CA (US); Sandra Smiley, Fresno, CA (US)

Correspondence Address: JAY M. SCHLOFF, 6960 Orchard Lake Road, Suite 315, West Bloomfield, MI, 48322, US

(21) Appl. No.: 12/348,352

(22) Filed: Jan. 5, 2009

(51) Int. Cl. G09B 11/06

(52) U.S. Cl. 434/88

(57) ABSTRACT

Disclosed is a portable tracing device. The portable tracing device assists in tracing a picture from a picture paper sheet onto a plain paper sheet. The portable tracing device comprises a housing and at least one light source. The housing includes a plurality of panels configured together to define an interior volume thereof. Further, at least one panel of the plurality of panels is cut to configure at least one window to secure at least one light transmissible panel thereon for providing a support to the picture paper sheet and the plain paper sheet. Furthermore, the at least one light source is disposed within the interior volume of the housing. The at least one light source emits a path of light through the at least one light transmissible panel such that the picture of the picture paper sheet is visible onto the plain paper sheet placed thereabove.

### FIELD OF THE INVENTION

The present invention relates to children's drawing devices, and more particularly, to a tracing device that assists a child in tracing and drawing figures onto a paper sheet, tracing sheet, and the like.

### BACKGROUND OF THE INVENTION

More often than not, children enjoy drawing pictures, such as cartoons, sceneries, and the like, onto ordinary paper by first observing such pictures. However, drawing such pictures onto the ordinary paper requires an artistic sensibility that usually lacking in most people, whether children or adults. One common way for accurately drawing such pictures is tracing such pictures onto tracing paper. Tracing paper is more light-transmissible than the ordinary paper. Placement of a tracing paper over a picture allows the picture to be seen through the tracing paper. The children or adults merely go over lines of the picture with a pen, a pencil, or a marker on the tracing paper to draw the picture onto the tracing paper.

However, the tracing papers are typically of lower quality than the ordinary papers. Further, the tracing papers are also typically less durable than the ordinary papers, and therefore when the tracing papers are folded, it leaves a visible mark of such folds. In addition, when the pictures on such poor quality paper are presented in front to anybody, he/she instantly knows that the pictures were not drawn from scratch, and have been copied.

Various types of tracing devices are also known, which facilitate children and adults' tracing of pictures onto the ordinary papers. Generally, a tracing device includes a transparent panel and a light source arranged in a manner such that light from the light source passes from the transparent panel, which facilitates a child or an adult to view a picture on ordinary paper for tracing the picture thereon. However, such tracing devices include complicated arrangements, which may be subject to significant deterioration during regular use of the tracing devices.

Accordingly, there exists a need for a tracing device that assists a child or an adult in tracing and drawing figures onto ordinary paper sheets as well as on a tracing sheet, and the like, if needed. Further, there exists a need for a tracing device with simple arrangements that facilitate easy use of the tracing device, and also may resist deterioration during regular use.

### SUMMARY OF THE INVENTION

In view of the forgoing disadvantages inherent in the prior art, the general purpose of the present invention is to provide a portable tracing device to include all advantages of the prior art, and to overcome the drawbacks inherent in the prior art.

An object of the present invention is to provide a portable tracing device that assists a child or an adult in tracing and drawing figures onto ordinary paper as well as on a tracing sheet, and the like.

Another object of the present invention is to provide a portable tracing device that has a simple arrangement for facilitating easy use thereof.

Another object of the present invention is to provide a portable tracing device that produces an even and effective iridescent glow for proper visualization of a picture that is to be traced.

To achieve the above objects, in an aspect of the present invention, a portable tracing device is provided. The portable tracing device is capable of assisting in tracing a picture from a picture paper sheet onto a plain paper sheet using a writing article. The portable tracing device comprises a housing, and at least one light source disposed within the housing. The housing includes a plurality of panels configured together to define an interior volume of the housing. At least one panel of the plurality of panel is cut to configure at least one window to secure at least one light transmissible panel thereon for providing a support to the picture paper sheet and the plain paper sheet. Further, the at least one light source is disposed within the interior volume of the housing. The at least one light source emits a path of light through the at least one light transmissible panel such that the picture of the picture paper sheet is visible on the plain paper sheet placed thereabove, thereby assisting in tracing the picture from the picture paper sheet onto the plain paper sheet using the writing article.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 illustrates a perspective view of a portable tracing device, in accordance with an exemplary embodiment of the present invention; and

FIG. 2 illustrates a top view of a portable tracing device having paper sheets disposed thereon, in accordance with another exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “top,” “bottom,” “first,” “second,” and the like, herein do not denote any order, elevation or importance, but rather are used to distinguish placement of one element over another. The terms “a” and “an” herein do not denote a limitation of quantity, but rather denote the presence of at least one of the referenced item.

The present invention provides a portable tracing device. The portable tracing device is capable of providing a platform for facilitating a child or an adult in tracing a picture easily and conveniently. Further, the portable tracing device produces an even and effective iridescent glow for proper visualization of the picture that is to be traced.

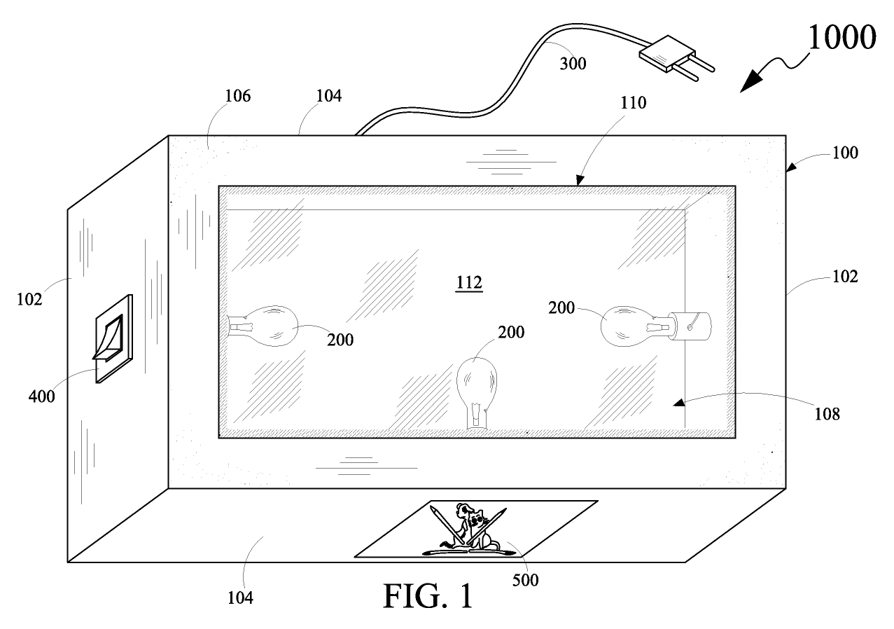

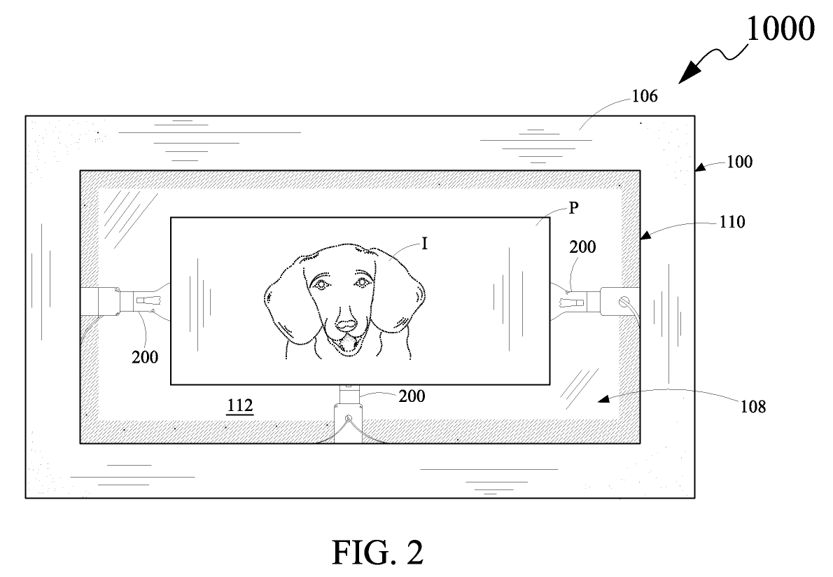

Referring now to FIGS. 1 and 2, various views of a portable tracing device 1000 are illustrated, in accordance with an exemplary embodiment of the present invention. More particularly, FIG. 1 illustrates a perspective view of the portable tracing device 1000, and FIG. 2 illustrates a top view of the portable tracing device 1000 having paper sheets disposed thereon. The portable tracing device 1000 includes a housing 100, and at least one light source. For the purpose of representation, three light sources are shown in FIGS. 1 and 2. However, it will evident to a person skilled in the art to include more or less than three light sources. The at least one light source, hereinafter, will be referred to as light sources 200.

The housing 100 is configured by a plurality of panels, such as a first pair of opposite side panels 102 (hereinafter referred to as ‘first side panels 102’), a second pair of opposite side panels 104 (hereinafter referred to as ‘second side panels 104’), a top panel 106, and a bottom panel (not shown). Each opposite side panels of the first side panels 102 are spaced apart at a predetermined distance, and disposed between the top panel 106 and the bottom panel at distal end portions thereof. Similarly, each opposite side panels of the second side panels 104 are spaced apart at a predetermined distance and disposed between the top panel 106 and the bottom panel at another distal end portions thereof. The predetermined distance between the first side panels 102 and the second side panels 104 may be set depending on a manufacturer's preference. Such an arrangement of the first side panels 102 and the second side panels 104 between the top panel 106, and the bottom panel configures the housing 100 having an interior volume 108 defined therewithin.

In one embodiment of the present invention, the first side panels 102, the second side panels 104, the top panel 106, and the bottom panel are wooden panels, which in turn form a wooden housing, such as the housing 100. However, it will be evident to person skilled in the art to configure a housing, such as the housing 100 from metal panels, plastic panels, and the like.

Further, at least one panel from the first side panels 102, the second side panels 104, the top panel 106, or the bottom panel is cut to configure at least one window. Without departing from the scope, in the present embodiment, the top panel 106 is cut to configure the at least one window, such as a window 110. However, it will be evident to a person skilled in the art to configure a window, such as the window 110 on any desired panel. The window 110 is adapted to secure at least one light transmissible panel, such as a light transmissible panel 112.

More particularly, the light transmissible panel 112 is secured onto the window 110 in such a manner that the light transmissible panel 112 provides a suitable platform to support a picture paper sheet (not numbered) and a plain paper sheet ‘P’ (as shown in FIG. 2). Without departing from the scope of the present invention, the light transmissible panel 112 has a length of about 11 inches, and a breadth of about 8½ inches that provides the suitable platform to support the picture paper sheet and the plain paper sheet ‘P’. However, it will be evident to a person skilled in the art to have any suitable length and breadth of a light transmissible panel, such as the light transmissible panel 112. In one embodiment of the present invention, the light transmissible panel 112 is a transparent glass panel that allows lights to pass therethrough. However, it will be evident to a person skilled in the art to employ the light transmissible panel 112 of any other transparent material, such a transparent plastic panel, and the like.

Further, the light sources 200 are disposed in the interior volume 108 of the housing 100. The light sources 200 emit a path of light that passes through the light transmissible panel 112. According to one embodiment of the present invention, the two light sources of the light sources 200 are disposed on inner surfaces (not numbered) of the first side panels 102, and remaining one light source of the light sources 200 is disposed on an inner surface (not numbered) of a side panel of the second side panels 104. Such placement positions of the light sources 200 produces even and effective iridescent glow for proper visualization. However, it will be evident to a person skilled in the art to dispose light sources, such as the light sources 200, at any suitable location within the interior volume 108 of the housing 100. The light sources 200 are electrically coupled to each other, and may be illuminated by a power source to emit the path of light.

According to one embodiment of the present invention, the power source may include an electric source, such as an electric wire 300. The electric wire 300 is electrically coupled to the light sources 200, and may illuminate the light sources 200, when connected to an electrical circuit carrying current. A length of the electric wire 300 is sufficient that allows the portable tracing device 1000 to be plugged into the electrical circuit carrying the current without any strain on the electric wire 300. According to another embodiment of the present invention, the power source may be a battery (not shown). The battery is electrically coupled to the light sources 200, which may illuminate the light sources 200. A use of the battery increases the portability of the portable tracing device 1000, and enables a user to use the portable tracing device 1000 at any suitable place.

Further, a switching mechanism 400 is associated with the power source, such as the electric wire 300 and the battery. The switching mechanism 400 operates the light sources 200. More particularly, the switching mechanism 400 is operated to switch on and switch off the light sources 200.

The portable tracing device 1000 has such a dimension thereof, which adds portability and usability to the portable tracing device 1000. In one embodiment of the present invention, the portable tracing device 1000 has about 13 inches of length, 10½ inches of breadth, and about 1½ inches of height. However, it will be evident to a person skilled in the art to configure the portable tracing device 1000 of any desired dimension. Further, the portable tracing device 1000 is provided with a space (not numbered), which may incorporate a logo 500 thereon.

It is understood from the preceding description that, when the light sources 200 disposed within the housing 100 of the portable tracing device 1000, are switched on, the light sources 200 emit the path of light through the light transmissible panel 112. For tracing a picture ‘I’ from the picture paper sheet to the plain paper sheet ‘P’, the plain paper sheet ‘P’ is placed above the picture paper sheet, and accordingly, both the picture paper sheet and the plain paper sheet ‘P’ are placed onto the light transmissible panel 112, (as shown in FIG. 2) such that a bottom side of the picture paper sheet faces the light transmissible panel 112. The path of light that is emitting through the light transmissible panel 112 provides visibility of the picture ‘I’ on the plain paper sheet ‘P’. The user, such as a child or an adult, may trace the picture ‘I’ onto the plain paper sheet ‘P’ merely by following or tracing outlines of the picture ‘I’ with a writing article (not shown). To accomplish the tracing, the writing article, such as a pen, a wax type pencil may be employed.

A portable tracing device, such as the portable tracing device 1000, of the present invention offer the following advantages. The portable tracing device is capable of allowing a child or an adult to trace a picture easily and conveniently. Further, the portable tracing device produces an even and effective iridescent glow for proper visualization of the picture that is to be traced. Further, provision of various means of powering the portable tracing device makes the portable tracing device readily available for use at a variety of places, such as schools, after school programs, day-cares and homes. Furthermore, the simple arrangement in the portable tracing device facilitates easy use thereof.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention

What is claimed is:

1. A portable tracing device for assisting in tracing a picture from a picture paper sheet onto a plain paper sheet using a writing article, the portable tracing device comprising:
a housing having a plurality of panels configured together to define an interior volume of the housing, wherein at least one panel of the plurality of panel is cut to configure at least one window to secure at least one light transmissible panel thereon for providing a support to the picture paper sheet and the plain paper sheet; and
at least one light source disposed within the interior volume of the housing, wherein the at least one light source emits a path of light through the at least one light transmissible panel such that the picture of the picture paper sheet is visible on the plain paper sheet placed thereabove, thereby assisting in tracing the picture from the picture paper sheet onto the plain paper sheet using the writing article.

2. The portable tracing device of claim 1, further comprising a power source for illuminating the at least one light source to emit the path of light.

3. The portable tracing device of claim 2, wherein the power source is an electric source.

4. The portable tracing device of claim 2, wherein the power source is a battery.

5. The portable tracing device of claim 2, further comprising a switching mechanism associated with the power source to operate the at least one light source.
